(19) United States
(12) Patent Application Publication
(10) Pub. No.: US 2008/0052439 A1
(43) Pub. Date: Feb. 28, 2008

(54) Portable Data Exchanger with Extended USB Interface

(76) Inventors: Sidney YOUNG, Hsin Chu (TW); David Q. Chow, San Jose, CA (US)

Correspondence Address: SINORICA, LLC, 528 FALLSGROVE DRIVE, ROCKVILLE, MD, 20850, US

(21) Appl. No.: 11/928,604

(22) Filed: Oct. 30, 2007

Related U.S. Application Data
(63) Continuation-in-part of application No. 11/624,667, filed on Jan. 18, 2007.
Application No. 11/624,667 is a division of application No. 09/478,720, filed on Jan. 6, 2000, now Pat. No. 7,257,714.
Application No. 09/478,720 is a continuation-in-part of application No. 09/366,976, filed on Aug. 4, 1999, now Pat. No. 6,547,130.
(63) Continuation-in-part of application No. 11/623,863, filed on Jan. 17, 2007.
Application No. 11/623,863 is a continuation-in-part of application No. 10/956,826, filed on Oct. 1, 2004, now Pat. No. 7,299,316.
(63) Continuation-in-part of application No. 11/864,696, filed on Sep. 28, 2007.

(51) Int. Cl. G06F 13/14

(52) U.S. Cl. 710/305

(57) ABSTRACT

The present invention discloses a portable data exchanger with extended USB interface. One portable data exchanger of the present invention can exchange data with another portable data exchanger of the same design connected thereto without using a computer. Further, the portable data exchanger with extended USB interface of the present invention is designed to have the hub-supporting USB OTG capability. Thus, the portable data exchanger with extended USB interface of the present invention not only can function as a slave to be controlled by a standard non-OTG USB host device but also can function as a host to control a standard non-OTG USB peripheral device. To be also compatible with the next generation devices, the present invention also proposes a portable data exchanger with extended USB interface using dual-personality extended USB plug and socket with PCI-express or SATA extensions.

### RELATED APPLICATIONS

This application is a continuation-in-part (CIP) of U.S. patent application Ser. No. 11/624,667, filed Jan. 18, 2007, entitled “Electronic Data Storage Medium with Fingerprint Verification Capability”, which is a division of application Ser. No. 09/478,720, filed on Jan. 6, 2000, which has been petitioned claiming benefit of Continuation-In-Process status of one of inventor's earlier U.S. patent application for “Integrated Circuit Card with Fingerprint Verification Capability”, U.S. application Ser. No. 09/366,976, filed Aug. 4, 1999, now issued as U.S. Pat. No. 6,547,130.

This application is also a CIP of U.S. patent application Ser. No. 11/623,863, filed Jan. 17, 2007, entitled “Secure Flash-Memory Card Reader with Host-Encrypted Data on a Flash-Controller-Mastered Bus Parallel to a Local CPU Bus Carrying Encrypted Hashed Password and User ID”, which is a CIP of application Ser. No. 10/956,826, Filed Sep. 1, 2005, entitled “USB Card Reader”.

This application is also a CIP of U.S. patent application Ser. No. 11/864,696, filed Sep. 28, 2007, entitled “Backward Compatible Extended-MLC USB Plug And Receptacle With Dual Personality”.

### FIELD OF THE INVENTION

The present invention relates to a data exchanger, particularly to a portable data exchanger with extended USB interface.

### DESCRIPTION OF THE RELATED ART

With advance of semiconductor technology and popularization of computers, accessory memory devices also develop explosively. They are usually featherweight and thumb-sized USB flash drives.

A USB flash drive is a NAND-type flash memory data storage device integrated with a USB interface. The first USB flash drive was sold in early 2000. From then on, there have been so many brands and so many styles of USB flash drives appearing in markets, and manufacturers have found it become harder and harder to milk from the idea of only a thumb-sized portable storage device. Thus, there are various novel designs related to USB flash drives proposed.

A Pretec Electronics Corporation proposed a flash drive, called iDisk that can also double as a I-port USB hub. Thus, there is no net loss in number of available USB ports. That is good news for some laptop owners whose machines are often equipped with just 1 or 2 USB interfaces. An Eagle Tec Corporation further proposed a 1 GB USB flash drive with 2 USB hubs having a novel Y-shape appearance design.

A U.S. Pat. No. 6,654,841 disclosed a “USB interface flash memory card reader with a built-in flash memory”, wherein a USB interface flash memory card reader is attached with a built-in flash memory so that the card reader itself provides a function of data storage in addition to a function of reading data in a flash memory card or writing data into the flash memory card. An Imono Digitale Corporation proposed a USB flash memory device merged with a memory card reader, which can access many types of memory cards. The Imono Digitale Corporation also proposed a flash drive with a USB SIM card reader and a memory card reader, which can read a SIM card and many types of memory card.

A U.S. Pat. No. 7,181,053 disclosed a “USB drive mass storage device with optical fingerprint identification system”, wherein an optical fingerprint identification system is mounted in the housing of the mass storage device for use with the USB drive. A GIGAFLASH Technology Corporation proposed a fingerprint USB flash drive, wherein data access to the flash drive is authorized only upon positive fingerprint authentication, and users with different fingerprint attributes can choose the most suitable sensitivity of security level.

To access the data stored in a flash drive, the drive must be connected to a computer, either by plugging it into a USB host controller built into the computer, or into a USB hub. Flash drives are active only when plugged into a USB connection and draw all necessary power from the supply provided by that connection. The standard USB uses a master/slave architecture; a USB host acts as a master and a USB peripheral acts as a slave. Only the USB host can schedule the configuration and data transfers over the link. The USB peripherals cannot initiate data transfers, they only respond to instructions given by a host.

However, USB On-The-Go, which is a supplement to the USB 2.0 specification and normally abbreviated as USB OTG, changes that situation. Gadgets don't need to be pure peripherals; they can sometimes act as hosts. An example might be connecting a USB keyboard or printer to a handheld wireless device; or a USB printer that knows how to grab documents from certain peripherals and print them. The USB OTG compatible devices are able to initiate the session, control the connection and exchange Host/Peripheral roles between each other.

Since USB flash drives are so common carry-about storage devices, directly connecting such devices to each other rather than only to desktop (or laptop) computers is desirable.

Accordingly, the present invention proposes a portable data exchanger with extended USB interface, which has the USB OTG capability and can exchange data with another portable data exchanger with extended USB interface connected thereto without using a computer.

### SUMMARY OF THE INVENTION

One objective of the present invention is to provide a portable data exchanger with extended USB interface, which is a USB flash drive having a controller chip having the UBS OTG (On-The-Go) capability, at least one battery and an additional USB female connector, wherein the portable data exchanger with extended USB interface can work without a computer, and wherein one portable data exchanger with extended USB interface can exchange data with another portable data exchanger with extended USB interface of the same design connected thereto without using a computer.

Another objective of the present invention is to provide a portable data exchanger with extended USB interface, which is a USB flash drive having a controller chip having the hub-supporting USB OTG capability, at least one battery and an additional USB female connector, wherein the portable data exchanger with extended USB interface of the present invention not only can function as a slave to be controlled by a standard non-OTG USB host device but also can function as a host to control a standard non-OTG USB peripheral device.

Yet another objective of the present invention is to provide a portable data exchanger with extended USB interface, which has an information security function.

Still another objective of the present invention is to provide a portable data exchanger with extended USB interface, which can double as a card reader.

Further objective of the present invention is to provide a portable data exchanger with extended USB interface, which can double as a SIM card reader.

Further objective of the present invention is to provide a portable data exchanger with extended USB interface, which can double as a USB hub.

Still further objective of the present invention is to provide a portable data exchanger with extended USB interface, which is compatible with the devices having a higher speed serial bus interface.

To achieve the abovementioned objectives, the present invention proposes a portable data exchanger with extended USB interface, which comprises: a top housing, a bottom housing, a flash memory chip, a control chip, a printed circuit board, a battery, a USB male connector, a USB female connector, and a switch device, wherein the flash memory chip, control chip, USB male connector, USB female connector, switch device, etc., are assembled to the printed circuit board to form a printed circuit board assembly, and wherein the printed circuit board assembly is encapsulated inside the top housing and the bottom housing, and wherein the switch device has a button on the surface of the housing, and pressing down the button can start the data exchanger to work or shut off the data exchanger.

In one embodiment of the present invention, the portable data exchanger with extended USB interface also has an information security design, such as a fingerprint sensor, a SIM card reader, or a personal identity.

In still another embodiment of the present invention, the portable data exchanger with extended USB interface further comprises a USB flash memory card reader controller and a USB flash memory card reader, a user can access multiple types of flash memory cards via the portable data exchanger with extended USB interface of the present invention.

In further embodiment of the present invention, the portable data exchanger with extended USB interface further comprises a USB SIM card reader controller and a USB SIM card reader, and a user can read, edit, and write data of a SIM card via the portable data exchanger with extended USB interface of the present invention.

In further embodiment of the present invention, the portable data exchanger with extended USB interface further comprises a USB hub controller and a USB hub, and the data exchanger will not decrease the available USB sockets when the data exchanger is connected to a computer but can even increase the available UBS sockets if the USB hub has more than one USB socket.

In still further embodiment of the present invention, the portable data exchanger with extended USB interface further comprises a high-speed serial bus interface controller, and the standard USB male and female connectors are respectively replaced by a dual-personality extended USB plug and a dual-personality extended USB socket, wherein both the extended USB plug and socket can double as the connectors for a higher speed serial bus interface without interfering with the function of the standard USB male and female connectors.

Below, the embodiments will be described in detail in cooperation with the drawings to make easily understood the objectives, technical contents, characteristics and accomplishments of the present invention.

### BRIEF DESCRIPTION OF THE DRAWINGS

FIG. 1 is a block diagram schematically showing the architecture of a first embodiment of the present invention;

FIG. 2 is a perspective view schematically showing the interior of a portable data exchanger with extended USB interface according to the first embodiment of the present invention;

FIG. 3 is a block diagram schematically showing the architecture of a second embodiment of the present invention;

FIG. 4 is a perspective view schematically showing the interior of a portable data exchanger with extended USB interface according to the second embodiment of the present invention;

FIG. 5 is a block diagram schematically showing the architecture of a third embodiment of the present invention;

FIG. 6 is a perspective view schematically showing the interior of a portable data exchanger with extended USB interface according to the third embodiment of the present invention;

FIG. 7 is a block diagram schematically showing the architecture of a fourth embodiment of the present invention;

FIG. 8 is a perspective view schematically showing the interior of a portable data exchanger with extended USB interface according to the fourth embodiment of the present invention;

FIG. 9 is a block diagram schematically showing the architecture of a fifth embodiment of the present invention;

FIG. 10 is a perspective view schematically showing the interior of a portable data exchanger with extended USB interface according to the fifth embodiment of the present invention;

FIG. 11 is a block diagram schematically showing the architecture of a sixth embodiment of the present invention; and

FIG. 12 is a perspective view schematically showing the interior of a portable data exchanger with extended USB interface according to the sixth embodiment of the present invention.

### DETAILED DESCRIPTION OF THE INVENTION

Below, the technical contents will be described with the embodiments in detail in cooperation with the attached drawings.

### Embodiment I

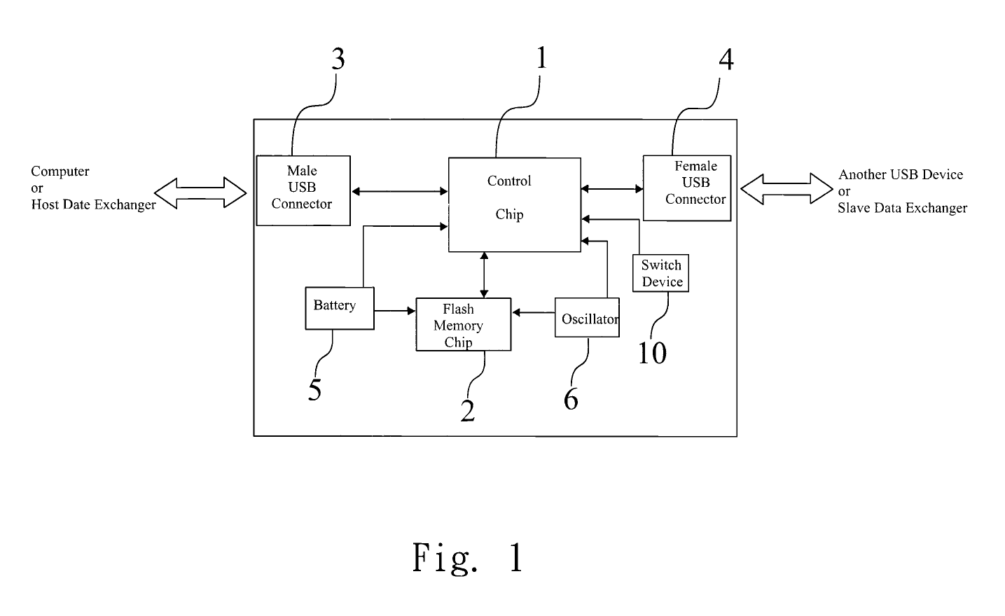

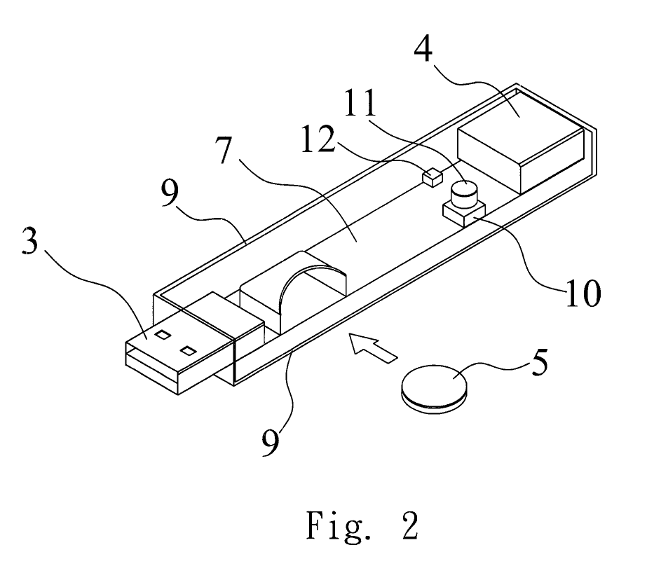

Refer to FIG. 1 and FIG. 2 respectively a block diagram schematically showing the architecture of a first embodiment of the present invention and a perspective view schematically showing the interior of a portable data exchanger with extended USB interface according to the first embodiment of the present invention. In the first embodiment, the portable data exchanger with extended USB interface of the present invention comprises: a controller chip 1 having the USB OTG capability, at least one flash memory chip 2, a USB male connector 3, a USB female connector 4, at least one battery 5, an oscillator 6, a printed circuit board 7, a top housing 8, a bottom housing 9, and a switch device 10, wherein the control chip 1, flash memory chip 2, USB male connector 3, USB female connector 4, oscillator 6, switch device 10, etc., are assembled to the printed circuit board 7 to form a printed circuit board assembly, and wherein the printed circuit board assembly is encapsulated inside the top housing 8 and the bottom housing 9, and wherein the switch device 10 has at least one button 11 on the surface of the housing, and pressing the buttons 11 can start the data exchanger to work, page operating commands, select the operating commands, or shut off the data exchanger.

In the first embodiment, as the portable data exchanger with extended USB interface has the USB female connector 4 and a power supply—the battery 5, and as the controller chip 1 thereof has the USB OTG capability, the portable data exchanger with extended USB interface can exchange data with another portable data exchanger with extended USB interface of the same design connected thereto without using a computer. When the USB male connector 3 of the portable data exchanger with extended USB interface is connected to the female connector 4 of another portable data exchanger with extended USB interface of the same design, the portable data exchanger with extended USB interface initially plays the role of slave, and another portable data exchanger with extended USB interface initially plays the roles of host, via pressing down the buttons 11 of them. When the USB male connector 3 of another portable data exchanger with extended USB interface is connected to the female connector 4 of the portable data exchanger with extended USB interface, the portable data exchanger with extended USB interface initially plays the role of host, and another portable data exchanger with extended USB interface initially plays the roles of slave, via pressing down the buttons 11 of them.

The USB On-The-Go includes a Host Negotiation Protocol (HNP). HNP allows two devices to exchange their host/slave roles, provide both are OTG devices. USB OTG defines two roles of devices: OTG A-device and OTG B-device. This terminology defines which side supplies power to the link, and which is initially the host. The OTG A-device is a power supplier, and an OTG B-device is a power consumer. The default link configuration is that A-device is a host and B-device is a slave. The host and slave modes may be exchanged later by using HNP.

Therefore, the portable data exchanger with extended USB interfaces of the present invention can exchange their host/slave roles later no matter what default roles they are initially. The portable data exchanger with extended USB interfaces of the present invention can exchange data with each other without using a computer. For example, the portable data exchanger with extended USB interfaces of the present invention can replace advertisement catalogs in a commercial exhibition or papers in a seminar to exchange data in situ, saving time, paper, and internet bandwidth.

USB OTG devices are backward compliant with USB 2.0 and will behave as standard USB hosts or slaves when connected to standard (no OTG) USB devices. However, OTG hosts are only required to provide a small amount of power, which may not be enough to connect to a non-OTG peripheral. This can sometimes be solved by connecting to the non-OTG peripheral through an externally powered hub if that OTG host supports hubs. (Such a support is not required by the standard USB OTG.)

Therefore, the portable data exchanger with extended USB interface of the present invention is designed to have the hub-supporting USB OTG capability. Thus, the portable data exchanger with extended USB interface of the present invention not only can function as a slave to be controlled by a standard non-OTG USB host device but also can function as a host to control a standard non-OTG USB peripheral device or initiate data exchange with a standard OTG USB peripheral device.

Further, the portable data exchanger with extended USB interface of the present invention may further comprises at least one LED 12 (Light Emitting Diode), which is used to indicate various states of the data exchanger.

Furthermore, the portable data exchanger with extended USB interface of the present invention may further comprises an LCD (Liquid Crystal Display) (not shown in the drawing), which can present the related information, such as the states, or the operating commands.

Moreover, the portable data exchanger with extended USB interface may be designed to exchange only an authentication code with another portable data exchanger with extended USB interface or compatible devices, and a user can use the authentication code to access data via the Internet.

### Embodiment II

Since the portable data exchanger with extended USB interface is carried about everywhere, it has a much higher probability to be lost than the immobile devices. Therefore, a mechanism for information security is necessary.

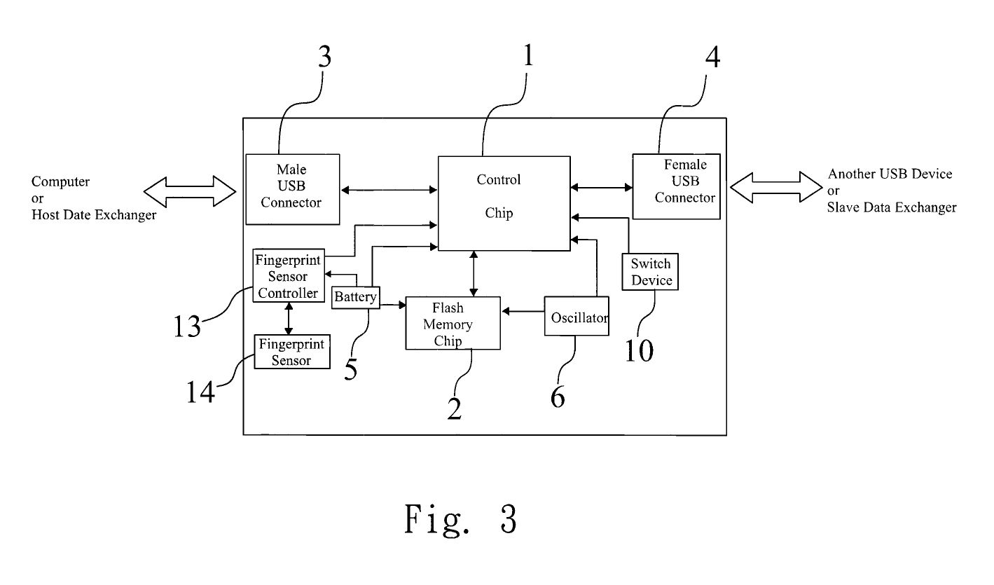

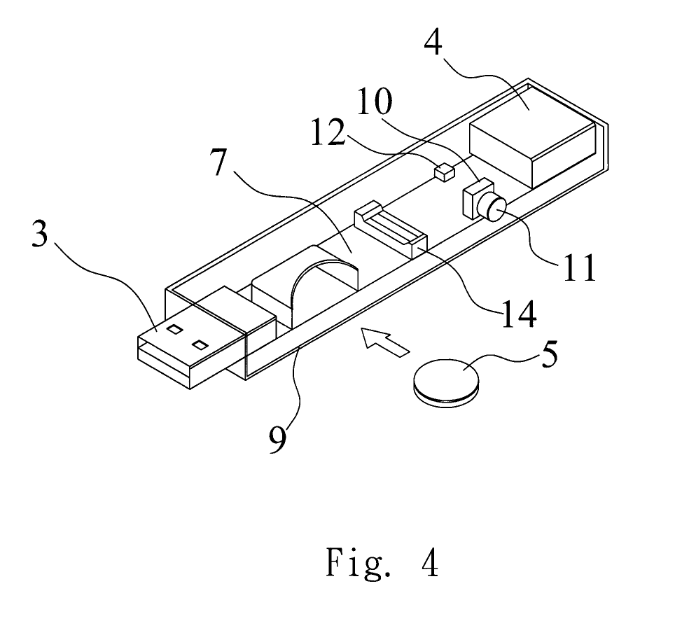

Refer to FIG. 3 and FIG. 4 respectively a block diagram schematically showing the architecture of a second embodiment of the present invention and a perspective view schematically showing the interior of a portable data exchanger with extended USB interface according to the second embodiment of the present invention. In the second embodiment, the present invention proposes a portable data exchanger with extended USB interface with a fingerprint identification mechanism to protect the data stored thereinside from being stolen. The second embodiment is based on the first embodiment but further comprises a fingerprint sensor controller and a fingerprint sensor. In the second embodiment, the portable data exchanger with extended USB interface of the present invention comprises: a controller chip 1 having the USB OTG capability, at least one flash memory chip 2, a USB male connector 3, a USB female connector 4, at least one battery 5, an oscillator 6, a printed circuit board 7, a top housing 8, a bottom housing 9, a switch device 10 having at least one button 11, a fingerprint sensor controller 13 and a fingerprint sensor 14, wherein the control chip 1, flash memory chip 2, USB male connector 3, USB female connector 4, oscillator 6, switch device 10, fingerprint sensor controller 13 and fingerprint sensor 14 are assembled to the printed circuit board 7 to form a printed circuit board assembly, and wherein the printed circuit board assembly is encapsulated inside the top housing 8 and the bottom housing 9.

In the second embodiment, the fingerprint sensor controller 13 can store at least one set of fingerprint. A user can press one of his fingers onto the fingerprint sensor 14 to input his fingerprint, and the fingerprint will be stored in the fingerprint sensor controller 13 as an authentication fingerprint. When a user intending to use the data exchanger presses down the button 11, he will be required to input his fingerprint. After the user inputs his fingerprint via the fingerprint sensor 14, the fingerprint sensor controller 13 compares the input fingerprint with the authentication fingerprints stored therein. If the authentication result is positive, the fingerprint sensor controller 13 will notify the controller chip 1 to start.

In the second embodiment, the fingerprint sensor controller 13 may be incorporated with the controller chip 1 to form a single control chip.

The other technical features of the second embodiment are similar to those of the first embodiment and will not repeat here.

### Embodiment III

There are many types of flash memory cards prevailing at present, and there are also various card readers to read/write flash memory cards. Most of card readers support the USB standard, and some card readers can read/write several types of flash memory cards. If a flash memory drive can integrate with a multi-card reader, users will be greatly convenienced. Therefore, the present invention also proposes a portable data exchanger with extended USB interface with a USB multi-card reader.

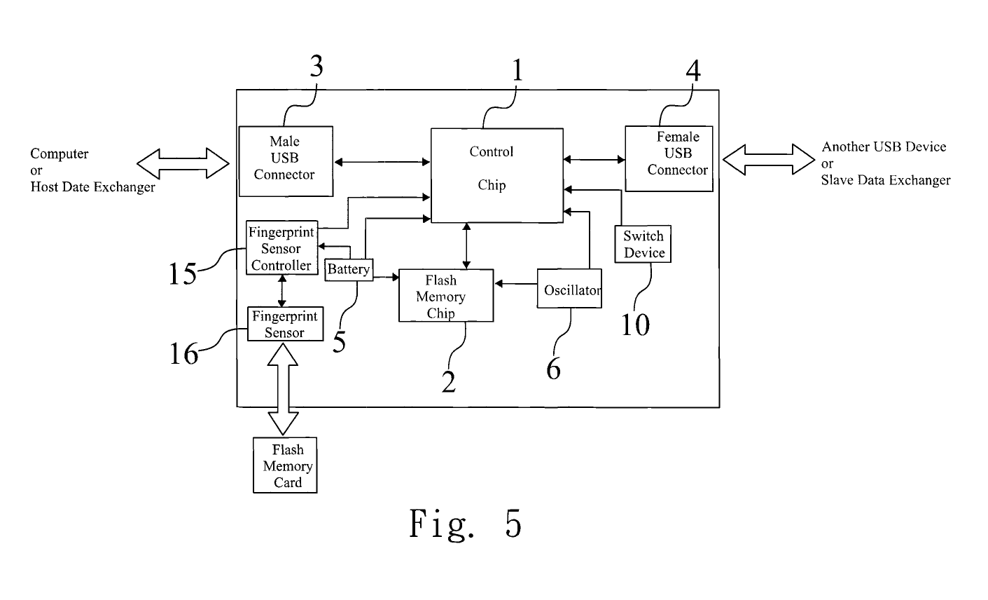

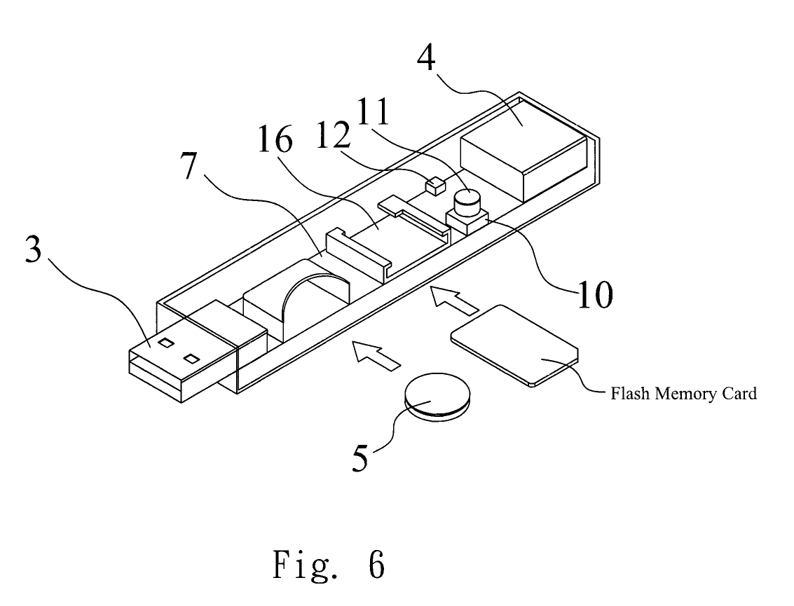

Refer to FIG. 5 and FIG. 6 respectively a block diagram schematically showing the architecture of a third embodiment of the present invention and a perspective view schematically showing the interior of a portable data exchanger with extended USB interface according to the third embodiment of the present invention. The third embodiment is based on the first embodiment but further comprises a USB flash memory card reader controller and a USB flash memory card reader. In the third embodiment, the portable data exchanger with extended USB interface of the present invention comprises: a controller chip 1 having the USB OTG capability, at least one flash memory chip 2, a USB male connector 3, a USB female connector 4, at least one battery 5, an oscillator 6, a printed circuit board 7, a top housing 8, a bottom housing 9, a switch device 10, a USB flash memory card reader controller 15 and a USB flash memory card reader 16, wherein the control chip 1, flash memory chip 2, USB male connector 3, USB female connector 4, oscillator 6, switch device 10, USB flash memory card reader controller 15 and USB flash memory card reader 16 are assembled to the printed circuit board 7 to form a printed circuit board assembly, and wherein the printed circuit board assembly is encapsulated inside the top housing 8 and the bottom housing 9.

In the third embodiment, since the portable data exchanger with extended USB interface has a card reader, external flash memory cards can thus function as the spare memories of the built-in flash memory chip 2. Then, the memory capacity of the portable data exchanger with extended USB interface can be easily expanded. Further, different data can be classified and stored in different external flash memory cards.

In the third embodiment, the USB flash memory card reader controller 15 may be incorporated with the controller chip 1 to form a single control chip.

The other technical features of the third embodiment are similar to those of the first embodiment and will not repeat here.

### Embodiment IV

Mobile phones have been very popular nowadays, and each mobile phone has its own SIM (Subscriber Identity Module) card. A user can use a SIM card reader to read, edit, and write data of a SIM card, such as the phone book or SMS (Short Message Service) messages thereinside. Therefore, integrating a SIM card reader with a flash drive will also considerably convenience users. Therefore, the present invention also proposes a portable data exchanger with extended USB interface with a USB SIM card reader.

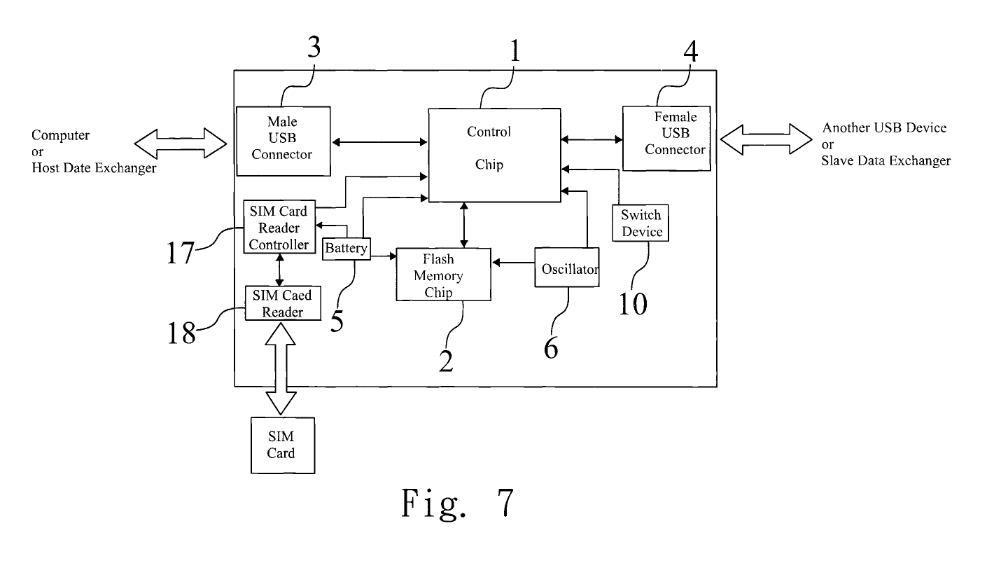

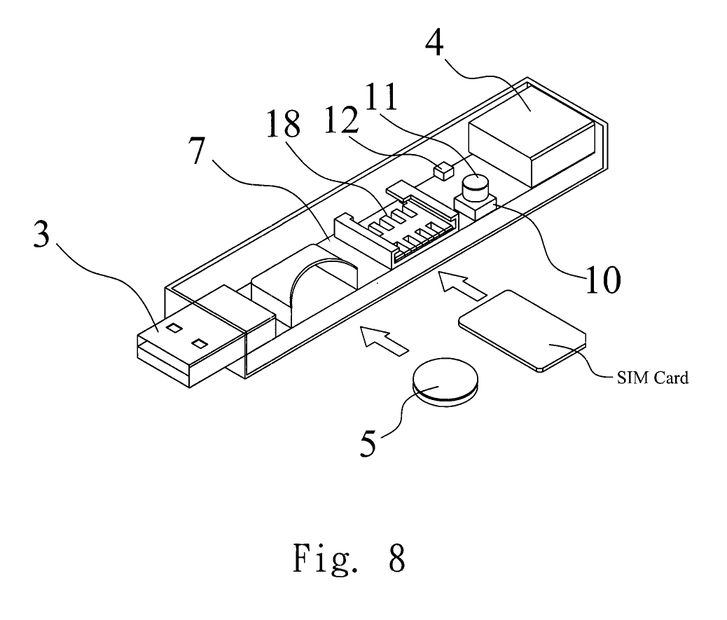

Refer to FIG. 7 and FIG. 8 respectively a block diagram schematically showing the architecture of a fourth embodiment of the present invention and a perspective view schematically showing the interior of a portable data exchanger with extended USB interface according to the fourth embodiment of the present invention. The fourth embodiment is based on the first embodiment but further comprises a USB SIM card reader controller and a USB SIM card reader. In the fourth embodiment, the portable data exchanger with extended USB interface of the present invention comprises: a controller chip 1 having the USB OTG capability, at least one flash memory chip 2, a USB male connector 3, a USB female connector 4, at least one battery 5, an oscillator 6, a printed circuit board 7, a top housing 8, a bottom housing 9, a switch device 10, a USB SIM card reader controller 17 and a USB SIM card reader 18, wherein the control chip 1, flash memory chip 2, USB male connector 3, USB female connector 4, oscillator 6, switch device 10, USB SIM card reader controller 17 and USB SIM card reader 18 are assembled to the printed circuit board 7 to form a printed circuit board assembly, and wherein the printed circuit board assembly is encapsulated inside the top housing 8 and the bottom housing 9.

In the fourth embodiment, the portable data exchanger with extended USB interface may be designed to check personal identity with a SIM card, and only a positive identification can start the portable data exchanger with extended USB interface.

In the fourth embodiment, the USB SIM card reader controller 17 may be incorporated with the controller chip 1 to form a single control chip.

The other technical features of the fourth embodiment are similar to those of the first embodiment and will not repeat here.

### Embodiment V

USB is the commonest interface protocol between a computer and a peripheral device. However, many computers have limited number of USB sockets, especially a laptop computer, which usually has only two or three USB sockets. Once one USB socket is occupied by the USB plug of a peripheral device, the rest of USB sockets may not afford necessary peripheral devices. Therefore, USB hubs are very popular nowadays. Therefore, a peripheral device having a USB hub will not decrease the available USB sockets when the peripheral device is connected to a computer but can even increase the available UBS sockets if the USB hub has more than one USB socket. Thus, the present invention also proposes a portable data exchanger with extended USB interface with a USB hub.

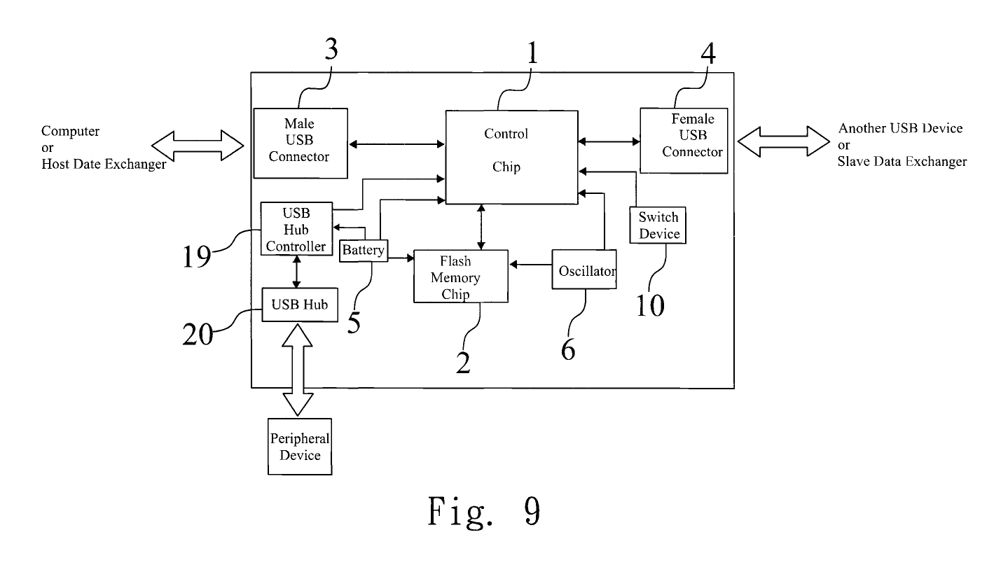

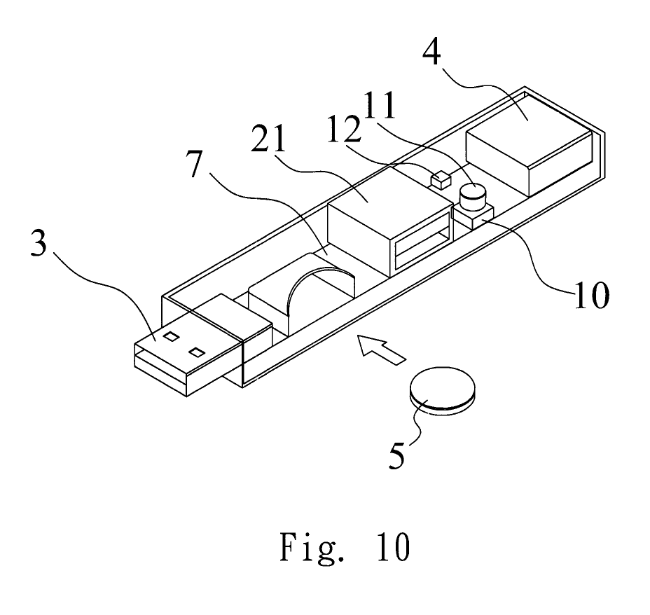

Refer to FIG. 9 and FIG. 10 respectively a block diagram schematically showing the architecture of a fifth embodiment of the present invention and a perspective view schematically showing the interior of a portable data exchanger with extended USB interface according to the fifth embodiment of the present invention. The fifth embodiment is based on the first embodiment but further comprises a USB hub controller and a USB hub. In the fifth embodiment, the portable data exchanger with extended USB interface of the present invention comprises: a controller chip 1 having the USB OTG capability, at least one flash memory chip 2, a USB male connector 3, a USB female connector 4, at least one battery 5, an oscillator 6, a printed circuit board 7, a top housing 8, a bottom housing 9, a switch device 10, a USB hub controller 19 and a USB hub 20, wherein the USB hub 20 has at least one USB socket 21, and wherein the control chip 1, flash memory chip 2, USB male connector 3, USB female connector 4, oscillator 6, switch device 10, USB hub controller 19, and USB hub 20 are assembled to the printed circuit board 7 to form a printed circuit board assembly, and wherein the printed circuit board assembly is encapsulated inside the top housing 8 and the bottom housing 9.

In the fifth embodiment, the USB hub controller 19 may be incorporated with the controller chip 1 to form a single control chip.

The other technical features of the fifth embodiment are similar to those of the first embodiment and will not repeat here.

### Embodiment VI

USB has been widely deployed as a standard for connecting a peripheral device to a personal computer. Currently, the top transfer rate of USB is 480 Mb/s, which is quite sufficient for most applications. However, faster serial bus interfaces are being introduced to address different requirements. PCI (Peripheral Component Interconnect) express at 2.5 Gb/s, and SATA (Serial Advanced Technology Attachment) at 1.5 Gb/s and 3.0 Gb/s, are two examples of high-speed serial bus interfaces for the next generation devices. To be also compatible with the next generation devices, the present invention also proposes a portable data exchanger with extended USB interface using dual-personality extended USB plug and socket with PCI-express or SATA extensions, especially which are based on a U.S. Pat. No. 7,021,971B2.

Each of the abovementioned extended USB plug and socket has a pin substrate with one surface that supports the four metal contact pins for the standard USB interface. Each of the extensions of the pin substrates of the plug and socket carries another 8 extension metal contact pins. The extension metal contact pins of the plug and socket mate each other when both the plug and socket are extended. The extension can be an increased length of the plug's and socket's pin substrate or the reverse side of the substrate. Standard USB connectors do not make contact with the extension metal contacts that are recessed or retracted by a mechanical switch, or on the extension of the socket's pin substrate that a standard USB connector cannot reach. Standard USB socket do not make contact with the extension because the extended connector's extension contacts are recessed, or on the extension of the connector pin substrate that does not fit inside a standard USB socket.

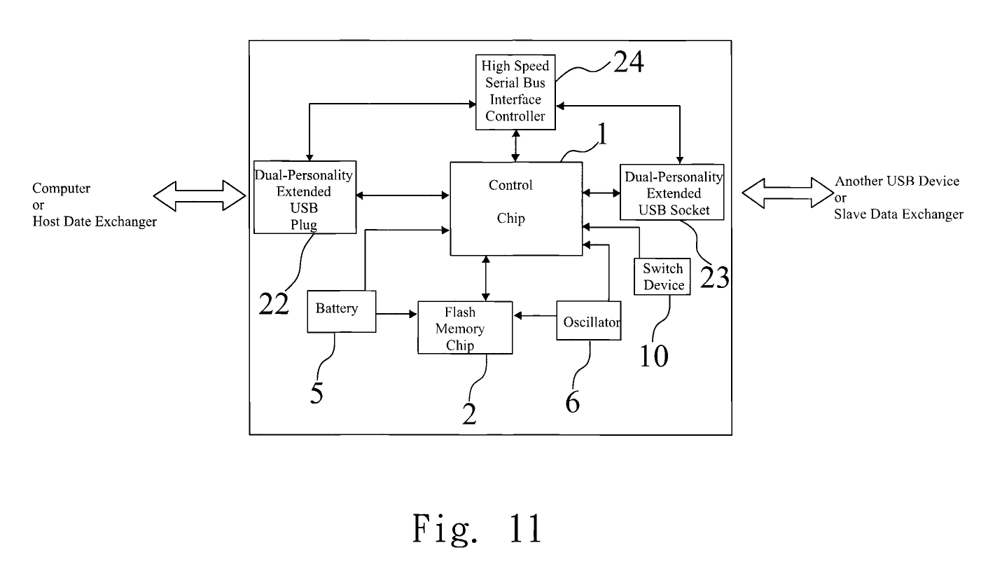

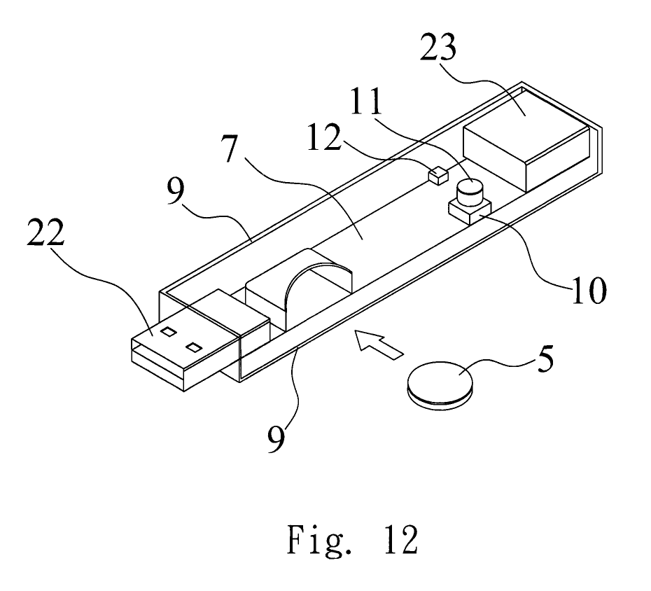

Refer to FIG. 11 and FIG. 12 respectively a block diagram schematically showing the architecture of a sixth embodiment of the present invention and a perspective view schematically showing the interior of a portable data exchanger with extended USB interface according to the sixth embodiment of the present invention. The sixth embodiment is based on the first embodiment but further comprises a high-speed serial bus interface controller, and the standard USB male and female connectors are respectively replaced by the abovementioned dual-personality extended USB plug and socket with PCI-express or SATA extensions. In the sixth embodiment, the portable data exchanger with extended USB interface of the present invention comprises: a controller chip 1 having the USB OTG capability, at least one flash memory chip 2, at least one battery 5, an oscillator 6, a printed circuit board 7, a top housing 8, a bottom housing 9, a switch device 10, a dual-personality extended USB plug 22, a dual-personality extended USB socket 23, a high-speed serial bus interface controller 24, wherein the control chip 1, flash memory chip 2, oscillator 6, switch device 10, dual-personality extended USB plug 22, dual-personality extended USB socket 23, and high-speed serial bus interface controller 24 are assembled to the printed circuit board 7 to form a printed circuit board assembly, and wherein the printed circuit board assembly is encapsulated inside the top housing 8 and the bottom housing 9.

In the sixth embodiment, the high-speed serial bus interface controller 24 may be incorporated with the controller chip 1 to form a single control chip.

The other technical features of the fifth embodiment are similar to those of the first embodiment and will not repeat here.

In conclusion, the portable data exchanger with extended USB interface of the present invention can exchange data with another portable data exchanger with extended USB interface of the same design connected thereto without using a computer. The portable data exchanger with extended USB interface of the present invention is designed to have the hub-supporting USB OTG capability, and the portable data exchanger with extended USB interface of the present invention not only can function as a slave to be controlled by a standard non-OTG USB host device but also can function as a host to control a standard non-OTG USB peripheral device. Further, the present invention also proposes a portable data exchanger with extended USB interface using dual-personality extended USB plug and socket with PCI-express or SATA extensions; thereby, the portable data exchanger with extended USB interface of the present invention is also compatible with the next generation devices. The portable data exchanger with extended USB interfaces of the present invention can replace paper documents to exchange data in various occasions and can exchange data in situ without via the Internet. Therefore, the present invention can save time, paper, and internet bandwidth.

Those described above are only the embodiments to exemplify the present invention but not to limit the scope of the present invention. Any equivalent modification or variation according to the spirit of the present invention is to be also included within the scope of the present invention.

What is claimed is:

1. A USB (Universal Serial Bus) interface portable data exchanger comprising:
at least one flash memory chip;
a controller chip coupled to said flash memory chip, having an USB OTG (On-The-Go) capability, and controlling reading and writing of said flash memory chip;
a USB male connector coupled to said controller chip;
a USB female connector coupled to said controller chip;
an oscillator providing a clock signal for said portable data exchanger with extended USB interface;
a switch device coupled to said controller chip having at least one button for users' operation;
a printed circuit board;
at least one battery providing power for said portable data exchanger with extended USB interface;
a top housing; and
a bottom housing;
wherein said flash memory chip, said controller chip, said USB male connector, said USB female connector, said oscillator, and said switch device are assembled onto said printed circuit board to form a printed circuit board assembly, and said printed circuit board assembly is encapsulated inside said top housing and said bottom housing, and wherein said controller chip having said USB OTG capability allows said portable data exchanger with extended USB interface to play either role of a host and a slave, and
wherein said portable data exchanger with extended USB interfaces exchange data with each other without using a computer.

2. The portable data exchanger with extended USB interface according to claim 1, wherein said controller chip has a hub-supporting USB OTG capability, and said portable data exchanger with extended USB interface is connected to a non-OTG peripheral device through an externally powered hub; thus, said portable data exchanger with extended USB interface not only functions as a slave to be controlled by a standard non-OTG USB host device but also functions as a host to control said standard non-OTG USB peripheral device.

3. The portable data exchanger with extended USB interface according to claim 1 further comprising at least one light emitting diode used to indicate various states of said portable data exchanger with extended USB interface.

4. The portable data exchanger with extended USB interface according to claim 1 further comprising a liquid crystal display used to present related information.

5. The portable data exchanger with extended USB interface according to claim 4, wherein pressing said button starts said portable data exchanger with extended USB interface to work, page operating commands, select said operating commands, or shut off said portable data exchanger with extended USB interface in cooperation with said liquid crystal display.

6. The portable data exchanger with extended USB interface according to claim 1 further comprising a fingerprint sensor controller and a fingerprint sensor, wherein after a user inputs his fingerprint via said fingerprint sensor, said fingerprint sensor controller compares said input fingerprint with authentication fingerprints stored therein; if authentication result is positive, said fingerprint sensor controller notifies said controller chip to start.

7. The portable data exchanger with extended USB interface according to claim 6, wherein said fingerprint sensor controller is incorporated with said controller chip to form a single control chip.

8. The portable data exchanger with extended USB interface according to claim 1, which is designed to exchange only an authentication code with another portable data exchanger with extended USB interface or compatible devices, wherein an user uses said authentication code to access data via the Internet.

9. The portable data exchanger with extended USB interface according to claim 1 further comprising a USB flash memory card reader controller and a USB flash memory card reader, which reads and writes at least one type of flash memory card.

10. The portable data exchanger with extended USB interface according to claim 9, wherein external flash memory cards function as spare memories of built-in flash memory chip and expand memory capacity of said portable data exchanger with extended USB interface.

11. The portable data exchanger with extended USB interface according to claim 9, wherein said USB flash memory card reader controller is incorporated with said controller chip to form a single control chip.

12. The portable data exchanger with extended USB interface according to claim 1 further comprising a USB SIM (Subscriber Identity Module) card reader controller and a USB SIM card reader, whereby an user reads, edits, and writes data of a SIM card.

13. The portable data exchanger with extended USB interface according to claim 12, which is designed to check personal identity with a SIM card, wherein only a positive identification starts said portable data exchanger with extended USB interface.

14. The portable data exchanger with extended USB interface according to claim 12, wherein said USB SIM card reader controller is incorporated with said controller chip to form a single control chip.

15. The portable data exchanger with extended USB interface according to claim 1 further comprising a USB hub controller and a USB hub having at least one USB socket, whereby said portable data exchanger with extended USB interface will not decrease available USB sockets for a computer when said portable data exchanger with extended USB interface is connected to said computer.

16. The portable data exchanger with extended USB interface according to claim 15, wherein said USB hub has more than one USB socket, and said portable data exchanger with extended USB interface increases available USB sockets for said computer when said portable data exchanger with extended USB interface is connected to said computer.

17. The portable data exchanger with extended USB interface according to claim 15, wherein said USB hub controller is incorporated with said controller chip to form a single control chip.

18. The portable data exchanger with extended USB interface according to claim 1 further comprising a high-speed serial bus interface controller, wherein said USB male connector and said female connector are respectively replaced by a dual-personality extended USB plug and a dual-personality extended socket both with PCI (Peripheral Component Interconnect)-express or SATA (Serial Advanced Technology Attachment) extensions, whereby said portable data exchanger with extended USB interface is compatible with related devices.

19. The portable data exchanger with extended USB interface according to claim 18, wherein each of said dual-personality extended USB plug and said dual-personality extended USB socket has a pin substrate with one surface that supports four metal contact pins for a standard USB interface; each of extensions of said pin substrates of said plug and said socket carries another 8 extension metal contact pins; said extension metal contact pins of said plug and said socket mate each other when both said plug and said socket are extended; said extension is an increased length of said pin substrates of said plug or said socket, or a reverse side of said substrate.

20. The portable data exchanger with extended USB interface according to claim 18, wherein said high-speed serial bus interface controller is incorporated with said controller chip to form a single control chip.
